(19) United States
(12) Patent Application Publication
(10) Pub. No.: US 2008/0209396 A1
(43) Pub. Date: Aug. 28, 2008

(54) Homepage for Modular Software

(75) Inventors: Weirong Ping, Hangzhou City (CN); Yanlong Sun, Hangzhou City (CN); Qinggen Chen, Fremont, CA (US)

Correspondence Address: PATENT LAW GROUP LLP, 2635 NORTH FIRST STREET, SUITE 223, SAN JOSE, CA, 95134, US

(73) Assignee: ARCSOFT, INC., Fremont, CA (US)

(21) Appl. No.: 11/680,242

(22) Filed: Feb. 28, 2007

(51) Int. Cl. G06F 9/44

(52) U.S. Cl. 717/120

(57) ABSTRACT

A multi-module application has a main module that generates a homepage user interface in a window for accessing a number of function modules of the application. Upon startup of the application, the main module parses a startup xml file that stores information about the function modules and generates the homepage user interface. When a user selects a function provided by a function module, the main module runs the function module and switches from the homepage user interface to a user interface of the function module in the same window. The user may return to the homepage from the function module by selecting a homepage button in the user interface of the function module. When a function module is added or removed from the application, an installer or uninstaller program updates the startup xml file by adding or removing information about the function module.

### FIELD OF INVENTION

This invention relates to methods for presenting and integrating modular software.

### DESCRIPTION OF RELATED ART

Software developers often make software for original equipment manufacturers (OEMs) to be bundled with hardware. It is natural for the OEMs to want to customize the OEM software by adding or removing components and to provide a way for the end users to upgrade the OEM software with additional components after the purchase of the hardware. Thus, what is needed is a way to seamlessly add and remove components to a software application while providing the look and feel of a single software application.

### BRIEF DESCRIPTION OF THE DRAWINGS

FIG. 1 is a block diagram of a multi-module application including a main module and a number of function modules in one embodiment of the invention.

FIG. 2 is a homepage user interface generated by the main module of FIG. 1 in one embodiment of the invention.

FIG. 3 is a block diagram of a startup xml file from which the main module of FIG. 1 generates the homepage user interface of FIG. 2 in one embodiment of the invention.

FIG. 4 is a flowchart of a method used by the main module of FIG. 1 to generate the homepage user interface of FIG. 2 in one embodiment of the invention.

FIG. 5 is a flowchart of a method used by the main module of FIG. 1 to switch from the homepage user interface of FIG. 2 to a user interface of a function module of FIG. 1 in one embodiment of the invention.

FIG. 6 is a flowchart of a method used by the main module of FIG. 1 to close a function module of FIG. 1 in one embodiment of the invention.

FIG. 7 is a flowchart of a method used by the main module of FIG. 1 to switch from a user interface of a function module of FIG. 1 to the homepage user interface of FIG. 2 in one embodiment of the invention.

FIG. 8 is a flowchart of a method by an installer program of FIG. 1 to add a function module and update the startup xml file of FIG. 3 in one embodiment of the invention.

FIG. 9 is a flowchart of a method by a uninstaller program of FIG. 1 to remove a function module and update the startup xml file of FIG. 3 in one embodiment of the invention.

Use of the same reference numbers in different figures indicates similar or identical elements.

### SUMMARY

In one embodiment of the invention, a multi-module application has a main module that generates a homepage user interface in a window for accessing a number of function modules of the application. Upon startup of the application, the main module parses a startup xml file that stores information about the function modules and generates the homepage user interface. When a user selects a function provided by a function module, the main module runs the function module and switches from the homepage user interface to a user interface of the function module in the same window. The user may return to the homepage from the function module by selecting a homepage button in the user interface of the function module. When a function module is added or removed from the application, an installer or uninstaller program updates the startup xml file by adding or removing information about the function module.

### DETAILED DESCRIPTION

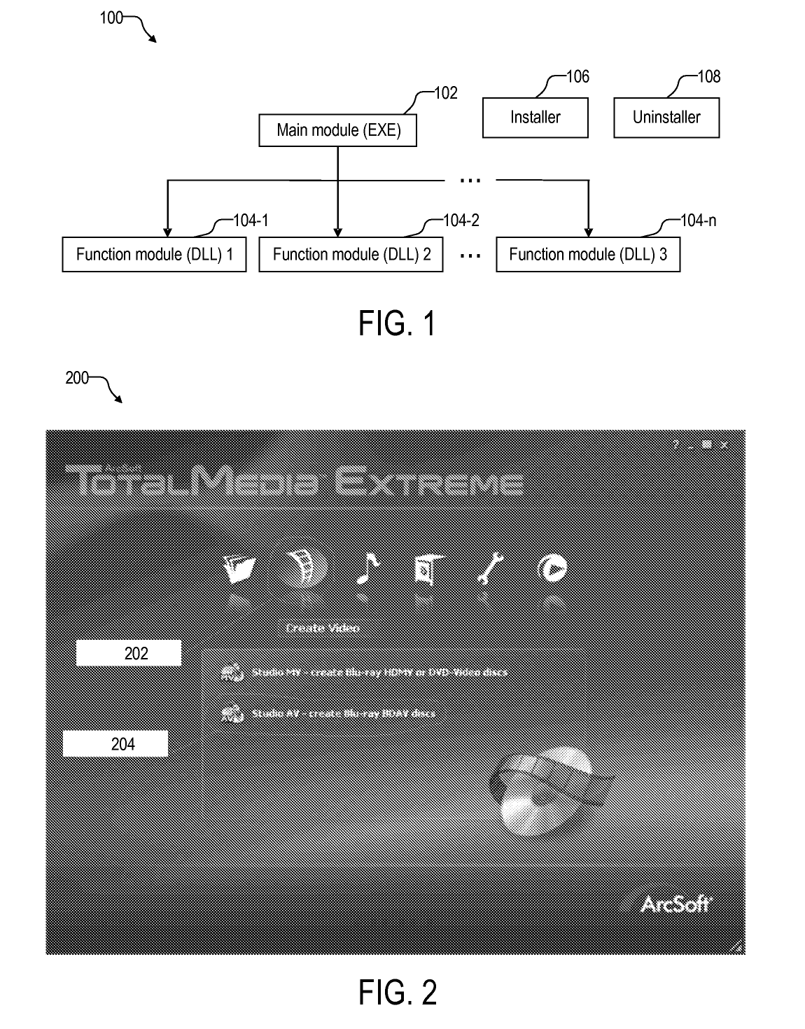

FIG. 1 is a block diagram of a multi-module application 100 in one embodiment of the invention. Application 100 may be executed by a processor in a personal computer or an appliance such as a Blue-ray Disk (BD) or a High Density (HD) Digital Video Disk (DVD) player. Application 100 includes a main module 102 and a group of function modules 104-1, 104-2 . . . 104-n that may be loaded into memory and executed by a processor. Main module 102 is an executable file that presents a user interface (UI) called a “homepage” for the user to view and launch function modules 104-1 to 104-n. Each function module is a Microsoft Windows dynamic link library (DLL) that provides a function to application 100, has its own UI, and works seamlessly with other modules to present the appearance of a single application.

Application 100 also includes an installer 106 and an uninstaller 108. Installer 106 and uninstaller 108 are DLLs that can be called to add and remove function modules 104-1 to 104-n from application 100.

FIG. 2 is an illustration of a homepage 200 in a window generated by main module 102 in one embodiment. Homepage 200 is the main UI for application 100 that allows the user to access the various functions provided by function modules 104-1 to 104-n. Homepage 200 includes a row of icons 202 (only one is labeled for clarity) for main functions provided by application 100. When the user moves a cursor over one of the main function icons 202, main module 102 presents a list of buttons 204 (only one is labeled for clarity) for sub-functions under the corresponding main function. The user can launch a sub-function by selecting the corresponding button 204.

The function modules, main functions, and sub-functions are related to each other in the following ways. First, each main function contains a number of related sub-functions. Second, a function module can provide multiple sub-functions under different main functions. Third, different function modules can provide different sub-functions under the same main function.

When the user selects a sub-function, main module 102 runs the corresponding function module that provides the sub-function, presents the UI of the corresponding function module in the same window as homepage 200, and hides homepage 200. This gives the appearance to the user of a single application whereas conventional software often has a launch pad application in a first window that launches another application in a second window while the launch pad application remains open in the first window. The UI of each function module may include a homepage button to return the user to homepage 200 in the same window.

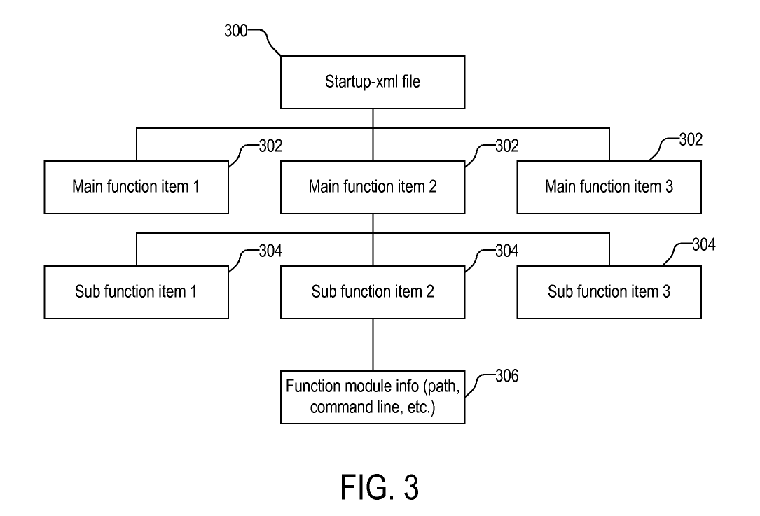

FIG. 3 illustrates a startup xml file 300 that main module 102 parses to generate homepage 200 in one embodiment of the invention. Startup xml file 300 includes main function items 302 for the main functions shown in homepage 200.

Each main function item 302 defines the ID number assigned to the main function, the icon of the main function in a UI file, and the name of the main function. The IDs assigned to the main functions are unique for each type of main function.

Each main function branches to sub-function items 304 for the sub-functions shown in homepage 200. Each sub-function item 304 defines the ID number assigned to the sub-function and the button of the sub-function in a UI file. The IDs assigned to the sub-functions are unique for each type of sub-function.

Each sub-function items 304 branches to function module information item 306. Each function module information item 306 defines a command line for calling a corresponding function module that provides the sub-function in application 100, and a command path for the command line.

A partial exemplary startup xml file 300 is listed below:

```
<?xml version=“1.0” encoding=“UTF-8”?>
<RocketApp>
<HomePage>
  <ITEM Name=“” AUIFile=“” ResAUIFile=“” Button=“”
NameStringID=“” BackgroundIcon=“”>
    < SUBITEM Name=“” AUIFile=“” ResAUIFile=“” Button=“”
    DescStringID=“” >
      <COMMAND Type=“” DllName=“” DllFile=“” CmdLine=“”/>
    </ SUBITEM>
    ...
  </ITEM >
  ...
</HomePage>
</RocketApp>
```

In the xml code above, the section [ITEM] is a main function item 302 where the main function ID is [Name], the main function icon is [Button] in an UI file named [AUIFile], the main function name is [NameStringID] in a resource file [ResAUIFile]. The section [SUBITEM] is a sub-function item 304 where the sub-function ID is [Name] and the button of the sub-function is [Button] in the UI file named [AUIFile]. The section [COMMAND] is a function module item 306 where the command path is stored in [DllFile] and the command line is stored in [CmdLine]. The resource file is used to store resource strings. The UI file stores UI elements, such as buttons and icons for the main and the sub-functions.

When a new function module is added, installer 106 adds the main function item or items of the new function module to startup xml file 300 if their main function IDs do not match the existing main function IDs already in startup xml file 300. Installer 106 also adds the sub-function item or items of the new function module to startup xml file 300 if their sub-function IDs do not match the existing sub-function IDs already in startup xml file 300.

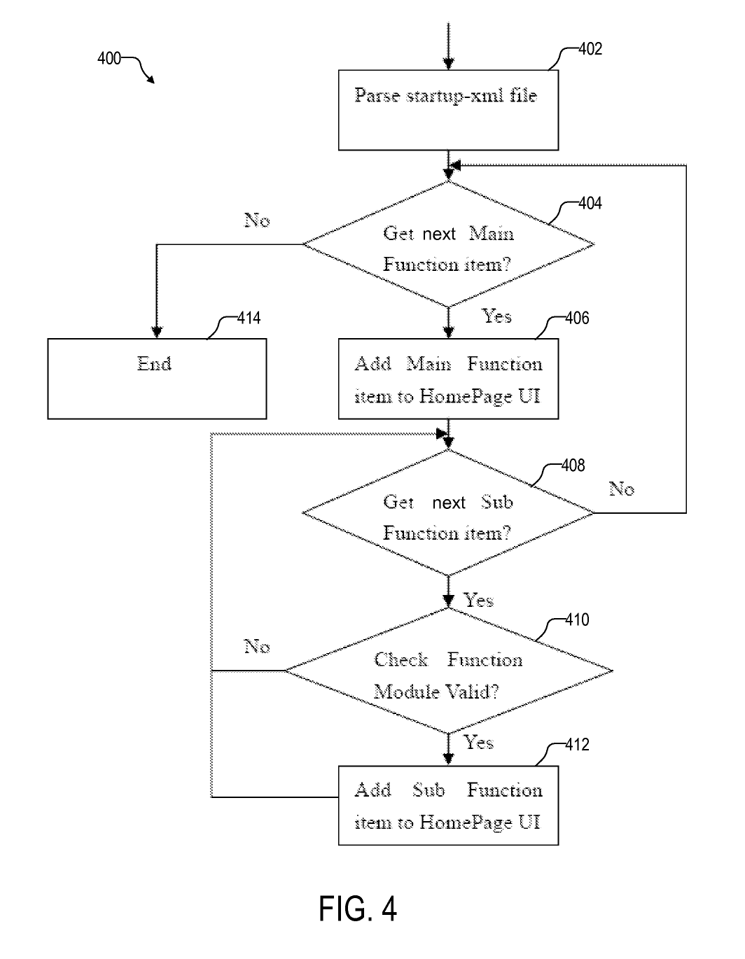

FIG. 4 is a flowchart of a method 400 for main module 102 to generate homepage 200 from startup xml file 300 in one embodiment of the invention.

In step 402, main module 102 parses startup xml file 300. Step 402 is followed by step 404.

In step 404, main module 102 determines if there is at least one main function item it has not processed for display in homepage 200. If so, main module 102 selects a remaining main function item in startup xml file 300 and step 404 is followed by step 406. Otherwise step 404 is followed by step 414 that ends method 400.

In step 406, main module 102 adds the selected main function to homepage 200. Step 406 is followed by step 408.

In step 408, main module 102 determines if there is at least one sub-function item under the selected main function item it has not processed for display in homepage 200. If so, main module 102 selects a remaining sub-function item in startup xml file 300 and step 408 is followed by step 410. Otherwise step 408 is followed by step 404.

In step 410, main module 102 determines if the function module for the selected sub-function item is valid. Specifically, main module 102 determines if the file path and the command line for the function module are still valid. If so, then step 410 is followed by step 412. Otherwise step 410 is followed by step 408.

In step 412, main module 102 adds the selected sub-function button to homepage 200. Step 410 is followed by step 408.

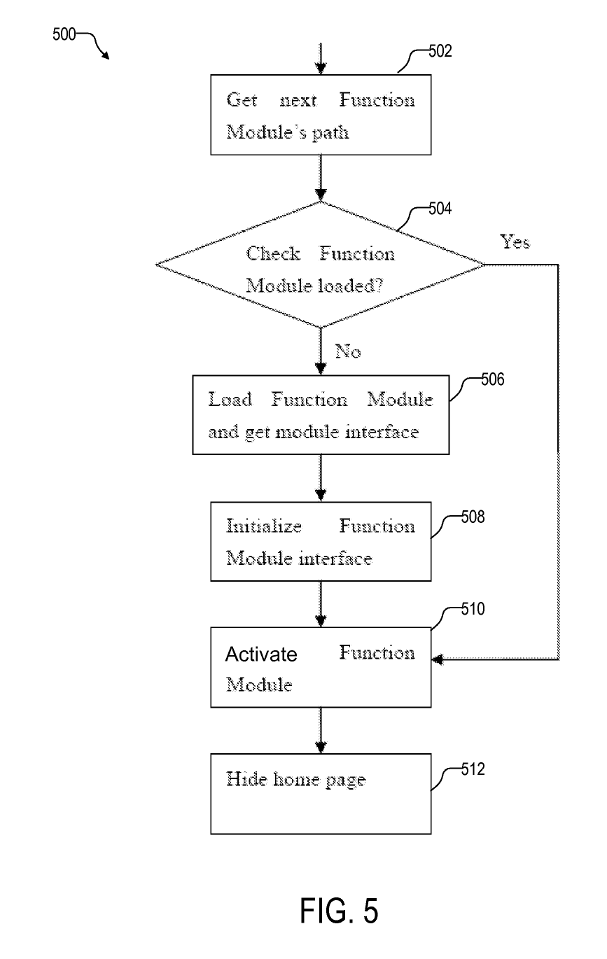

FIG. 5 is a flowchart of a method 500 of main module 102 to run a sub-function selected by a user from homepage 200 in one embodiment of the invention.

In step 502, main module 102 gets the path and the command line of the module function of the selected sub-function from startup xml file 300. Step 502 is followed by step 504.

In step 504, main module 102 determines if the function module is already loaded in memory. If so, step 504 is followed by step 510. Otherwise step 504 is followed by step 506.

In step 506, main module 102 loads the function module and retrieves the interface between main module 102 and the function module. Specifically, the function module provides an exported routine to create a function object, and the routine returns an object interface pointer for the function object. Thus, main module 102 retrieves the interface for the function module from the exported routine.

Each function module has an interface with main module 102 to receive the following commands or information: (1) module initialize/un-initialize, (2) module activate/deactivate, (3) query to close the module, (4) window messages from Window OS, and (5) different running parameters (command lines) to run the different sub-functions. Initialize is the command to load the function module into memory and to set the parameters of the function module, and un-initialize is the command to release the loaded function module from memory and to inform main application 102 to deregister the application from main module 102. Activate is the command to show the UI of the function module in the window and to hide of homepage 200 in the same window, and deactivate is the command to hide the UI of the function module in the window and to show homepage 200 in the same window.

Main module 102 has an interface with the function modules to receive the following commands or information: (1) close entire application, (2) go to homepage, and (3) get main module information (e.g., window minimum size). Step 506 is followed by step 508.

In step 508, main module 102 initializes the function module interface. Step 508 is followed by step 510.

In step 510, main module 102 activates the function module to show the UI of the function module in the window. Step 510 is followed by step 512.

In step 512, main module 102 hides homepage 200 from the same window.

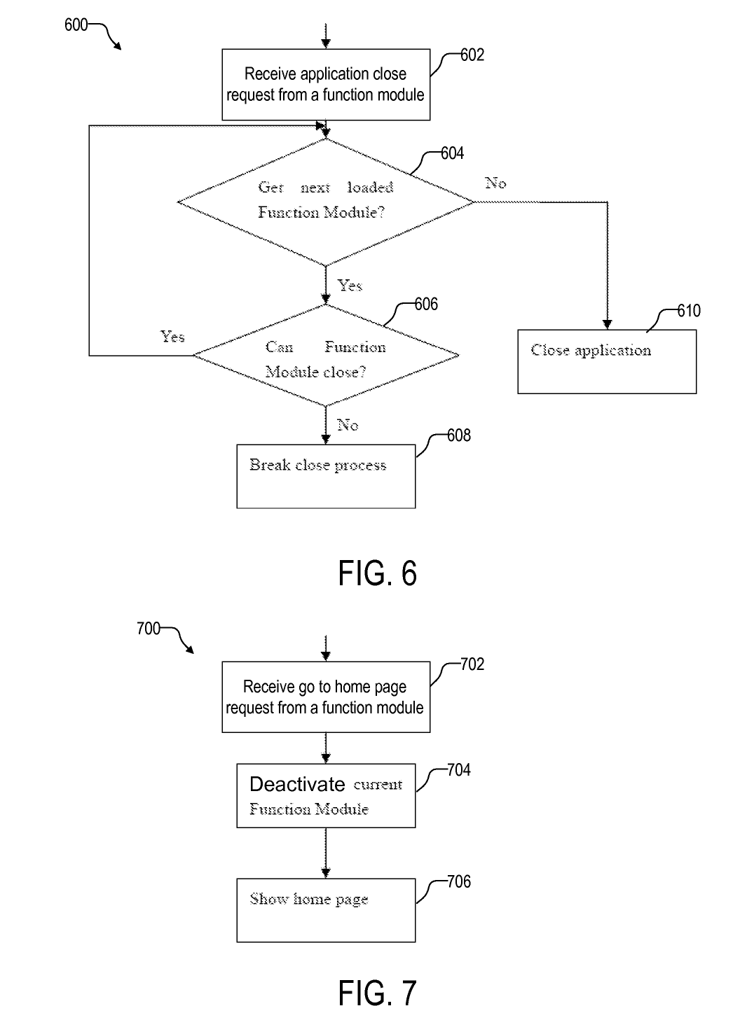

FIG. 6 is a flowchart of a method 600 for main module 102 to close application 100 in one embodiment of the invention.

In step 602, main module 102 receives a request to close application 100 from the user when the user selects to exit the application from the homepage or the UI of a function module. Step 602 is followed by step 604.

In step 604, main module 102 determines if there is at least another function module loaded in memory that it has not processed in regards to the request to close application 100. If so, main module 102 selects a remaining function module loaded in memory and step 604 is followed by step 606. Otherwise step 604 is followed by step 610.

In step 606, main module 102 queries a remaining function module if main module 102 may close application 100. A function module loaded in memory would agree that application 100 may be closed if the function module is not processing any task. If so, then step 606 is followed by step 604. Otherwise step 606 is followed by step 608.

In step 608, main module 102 breaks the closing process and application 100 remains running.

In step 610, main module 102 closes application 100 by instructing the function modules to un-initialize.

FIG. 7 is a flowchart of a method 700 of main module 102 to return from the UI of a function module to homepage 200 in one embodiment of the invention.

In step 702, main module 102 receives a request to return to homepage 200 from the function module. This is in response to a user selecting a homepage button on the UI of the function module.

In step 704, main module 102 deactivates the function module to hide the UI of the function module from the window.

In step 706, main module 102 shows homepage 200 in the same window.

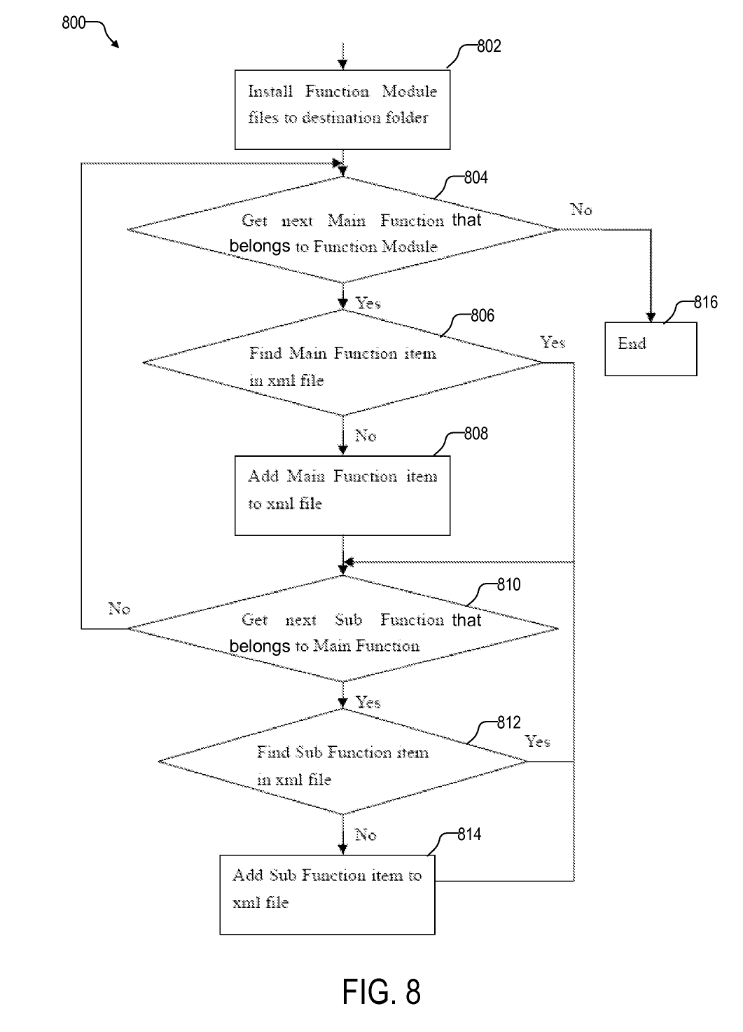

FIG. 8 is a flowchart of a method 800 for an installer program 106 executed by a processor to update startup xml file 300 when a new function module is added to application 100 in one embodiment of the invention.

In step 802, installer program 106 saves the new function module files to a destination folder. Step 802 is followed by step 804.

In step 804, installer program 106 determines if there is at least one main function that belongs to the new function module that it has not process for addition to startup xml file 300. If so, installer program 106 selects a remaining main function and step 804 is followed by step 806. Otherwise step 804 is followed by step 816 that ends method 800.

In step 806, installer program 106 determines if a main function item for the selected main function is in startup xml file 300. If the main function item is not in startup xml file 300, then step 806 is followed by step 808. Otherwise step 806 is followed by step 810.

Installer program 106 determines if the main function item of the selected main function is in startup xml file 300 by comparing the ID of the selected main function against the IDs stored in the existing main function items in startup xml file 300. If the ID of the selected main function matches the ID stored in an existing main function item, then the main function item for the selected main function is already in startup xml file 300.

In step 808, installer program 106 adds the main function item of the selected main function to startup xml file 300. Step 808 is followed by step 810.

In step 810, installer program 106 determines if there is any sub-function that belongs to the selected main function that it has not process for addition to startup xml file 300. If so, install program 106 selects a remaining sub-function and step 810 is followed by step 812. Otherwise step 810 is followed by step 804 where the above steps are repeated until all the main function items that belong to the new function module have been added to startup xml file 300.

In step 812, installer program 106 determines if a sub-function item for the selected sub-function is in startup xml file 300. If the sub-function item is not in startup xml file 300, then step 812 is followed by step 814. Otherwise step 812 is followed by step 810.

Installer program 106 determines if the sub-function item of the selected sub-function is in startup xml file 300 by comparing the ID of the selected sub-function against the IDs stored in the existing sub-function items in startup xml file 300. If the ID of the selected sub-function matches the ID stored in an existing sub-function item, then the sub-function item for the selected sub-function is already in startup xml file 300.

In step 814, installer program 106 adds the sub-function item for the selected sub-function to startup xml file 300. Specifically, the sub-function item branches from its main function item in startup xml file 300. Step 814 is followed by step 810 where the above steps are repeated until all the sub-function items that belong to the new function module have been added to startup xml file 300.

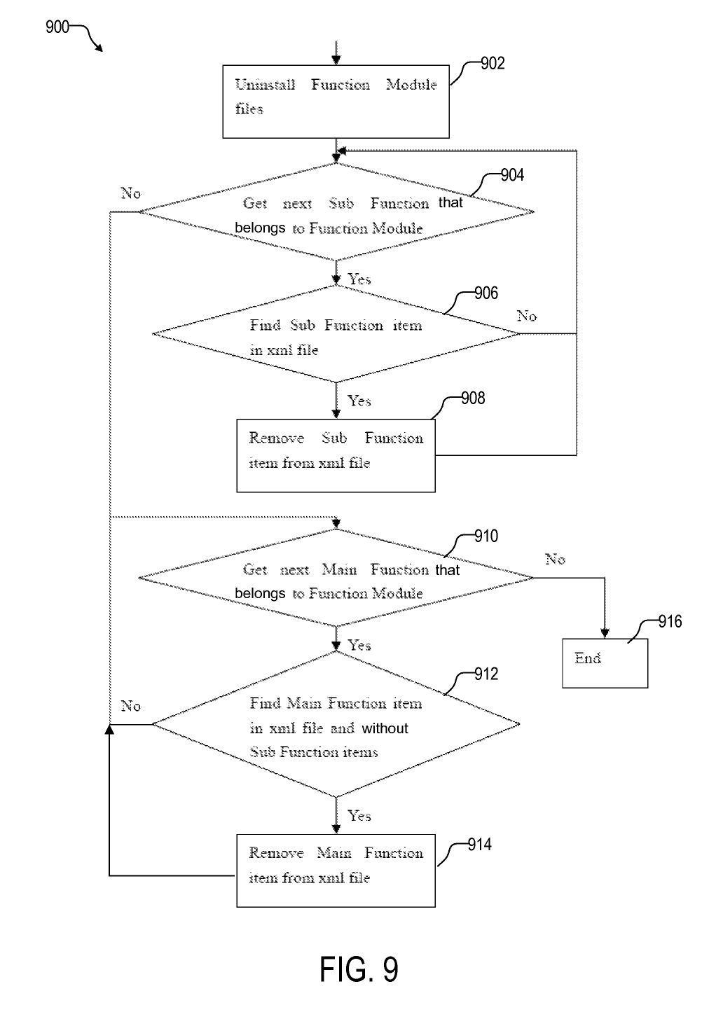

FIG. 9 is a flowchart of a method 900 for an uninstaller program 108 executed by a processor to update startup xml file 300 when a function module is removed from application 100 in one embodiment of the invention.

In step 902, uninstaller program 108 deletes the existing function module files from their folder. Step 902 is followed by step 904.

In step 904, uninstaller program 108 determines if there is at least one sub-function item that belongs to the function module that it has not process for deletion from startup xml file 300. If so, uninstaller program 108 selects a remaining sub-function item and step 904 is followed by step 906. Otherwise step 904 is followed by step 910.

In step 906, uninstaller program 108 determines if the sub-function item for the selected sub-function is in startup xml file 300. If the selected sub-function item is not in startup xml file 300, then step 906 is followed by step 904. Otherwise step 906 is followed by step 908.

Uninstaller program 108 determines if the sub-function item is in startup xml file 300 by comparing the ID of the selected sub-function against the IDs stored in the existing sub-function items in startup xml file 300. If the ID of the selected sub-function does not match any of the IDs stored in the existing sub-function items, then the sub-function item for the selected sub-function has already been deleted from startup xml file 300.

In step 908, uninstaller program 108 deletes the sub-function item from startup xml file 300. Step 908 is followed by step 904 where the above steps are repeated until all the sub-function items that belong to the function module to be removed have been deleted from startup xml file 300.

In step 910, uninstaller program 108 determines if there is at least one main function that belongs to the function module that it has not processed for deletion from startup xml file 300. If so, uninstaller program 108 selects a remaining main function and step 910 is followed by step 912. Otherwise step 910 is followed by step 916 that ends method 900.

In step 912, uninstaller program 108 determines if the main function item for the selected main function is in startup xml file 300. If the main function item is not in startup xml file 300, then step 912 is followed by step 910. Otherwise step 912 is followed by step 914.

Uninstaller program 108 determines if the selected main function item is in startup xml file 300 by comparing the ID of the selected main function against the IDs stored in the existing main function items in startup xml file 300. If the ID of the selected main function does no match nay of the IDs stored in the existing main function items, then the main function item for the selected main function has already been deleted from startup xml file 300.

In step 914, uninstaller program 108 deletes the main function item for the selected main function from startup xml file 300. Step 914 is followed by step 910 where the above steps are repeated until all the main function items that belong to the function module to be removed have been deleted from startup xml file 300.

Various other adaptations and combinations of features of the embodiments disclosed are within the scope of the invention. Numerous embodiments are encompassed by the following claims.

What is claimed is:

1: A method for a main module of a multi-module application to generate a homepage user interface for accessing function modules of the application, comprising:
parsing a startup file for a plurality of first data items storing main functions of the application;
adding the main functions to the homepage user interface;
parsing the startup file for a plurality of second data items storing sub-functions of the main functions;
determining if the function modules of the corresponding sub-functions are valid;
adding the corresponding sub-functions of the valid function modules to the homepage user interface; and
displaying the homepage user interface in a window.

2: The method of claim 1, further comprising:
receiving a user selection of a sub-function;
retrieving a path for a function module of the sub-function;
loading the function module if the function module is not already loaded in memory;
initializing a function module interface of the function module; and
activating the function module to show a user interface of the function module in the window and hide the homepage user interface from the window.

3: The method of claim 2, further comprising;
receive a request from the function module to close the application;
if no other function module is loaded in memory, closing the application;
if another function module is loaded in memory, querying the another function module if the application may be closed;
if the another function module responds that the application may not be closed, aborting from closing the application; and
if the another function module responds that the application may be closed, closing the application.

4: The method of claim 2, further comprising:
receiving from the function module a request to go to the homepage user interface; and
deactivating the function module to hide the user interface of the function module from the window and show the homepage user interface in the window.

5: The method of claim 1, further comprising:
saving a new function module to a folder;
getting a new main function of the new function module;
parsing the first data items in the startup file for the main functions in the application and adding a new main function item of the new function module to the startup file if none of the main functions matches the new main function;
getting a new sub-function of the new function module; and
parsing the second data items in the startup file for the sub-functions in the application and adding a new sub-function item of the new sub-function module to the startup file if none of the sub-functions matches the new sub-function.

6: The method of claim 1, further comprising:
deleting an old function module from a folder;
parsing the second data items in the startup file of the application and deleting any sub-function items of the old sub-function module from the startup file; and
parsing the first data items in the startup file of the application and deleting any main function items of the old function module from the startup file.
